(19) United States
(12) Patent Application Publication
(10) Pub. No.: US 2005/0159190 A1
(43) Pub. Date: Jul. 21, 2005

(54) Remote alerting unit for signaling users

(75) Inventor: Martin J. Dowling, Plymouth Meeting, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/736,165

(22) Filed: Dec. 15, 2003

Related U.S. Application Data
(60) Provisional application No. 60/519,798, filed on Nov. 13, 2003.

(51) Int. Cl. H04M 1/00

(52) U.S. Cl. 455/567

(57) ABSTRACT

A remote alerting device provides a user of a wireless transmit/receive unit (WTRU) with communications related to cellphone or other WTRU functions. This allows the user to respond and otherwise interact with the WTRU in a manner which enhances convenience and avoids disturbing others. In one configuration, the remote unit receives ring signals from calls which are identified as high priority, and provides the user with a vibratory signal corresponding to the ring. This permits the user to interact with the WTRU without having to physically access the WTRU.

### CROSS REFERENCE TO RELATED APPLICATION(S)

This application claims priority from U.S. provisional application No. 60/519,798 filed on Nov. 13, 2003, which is incorporated by reference as if fully set forth.

### FIELD OF INVENTION

This invention relates to wireless devices. The invention further relates to remote interfaces for such devices.

### BACKGROUND

One function of traditional cellphones is the ability to signal users to indicate an incoming call, such as by either a page message or an audible “ring”. Having a distinctive ring is advantageous in places where the ringing will not disturb other individuals. A traditional cellphone ring is less than desirable in other circumstances. This problem is currently addressed in various ways, ranging from a physical vibration of the cellphone to reduced volume “single tone” rings; however, the user needs to have the handset in close proximity to hear a “quiet ring” or feel the vibration. To illustrate, the handset may be stowed at a location which is not on the user's person, such as in a purse, jacket pocket or briefcase. If a cellphone is placed in vibration mode, the user may not feel it depending on where the user keeps the phone.

The problems of convenience are complicated by the fact that traditional cellphones are merging with other technologies. For example, it is possible to integrate a communications device into a laptop computer. Obviously it would be difficult to retrieve the laptop computer if not already in active use in order to make or receive a phone call. Therefore, the problems of convenience are exaggerated when cellphone capabilities are incorporated into a larger device. On the other hand, incorporation of cellphone capabilities into a larger device is desirable because it increases the overall functionality. If the user is carrying a larger device, such as a laptop computer with a wireless transmit receive unit (WTRU) module, it is desirable not to also carry a separate cellphone, even though the larger device is not always conveniently accessible.

### SUMMARY

According to the present invention, a silent alerting system includes a communications device and a wearable device. The wearable device includes a vibrator or other signal mechanism and a receiver that activates the vibrator upon receiving a predetermined signal, the communications device provides a local signal upon receipt of a call of a predetermined classification. In one particular configuration a WTRU includes a local radio link transmitter. The local radio link transmitter is receivable by a remote signaling unit, which provides a user with an indication of an incoming call according to the class of call received.

In one embodiment of the invention, the local signal provides communication with one or more remote communication units. This provides simultaneous communication between a wireless network connection and plural ones of the remote communication units.

### BRIEF DESCRIPTION OF THE DRAWINGS

FIG. 1 is a diagram of a system configuration in which a user receives communications from a cellular network indirectly by use of a remote device.

FIG. 2 is a diagram of the circuit components used to provide communications.

FIGS. 3A-3C are a functional flow diagram showing the operation of one embodiment.

FIGS. 4A-4D are functional flow diagrams showing specific operational examples for providing call notification.

FIGS. 5A-5B are functional flow diagrams showing specific operational examples for providing alerts.

### DETAILED DESCRIPTION OF THE PREFERRED EMBODIMENTS

The present invention permits remote communication with a user of a WTRU, so that the user may be alerted to important calls or otherwise communicate through the WTRU without having to respond to unimportant calls.

A wireless transmit/receive unit (“WTRU”) includes but is not limited to a user equipment (UE), mobile station, fixed or mobile subscriber unit, pager, or any other type of device capable of operating in a wireless environment. These exemplary types of wireless environments include, but are not limited to, wireless local area networks (WLANs) and public land mobile networks. A “base station” includes but is not limited to a base station, Node B, site controller, access point or other interfacing device in a wireless environment.

According to the present invention, remote alerting of a cellphone user is provided by a signal device worn or otherwise carried by the user as a remote device. In an exemplary embodiment, the device may be attached as a wristband and provides vibration when calls are received. In a specific configuration, a caller is requested to indicate a priority status of the call and the user is signaled through the remote signal device only for high priority calls or alternatively in a manner which distinguishes high priority calls from low priority calls.

According to one particular aspect of the invention, the WTRU is placed in a “remote signaling” mode, wherein the phone is in receive mode only in the network side, and transmit mode only in local point-to-point communication. When the WTRU receives the signal, it does not make a sound. (It may or may not vibrate.) The WTRU sends a unique point to point signal to a miniature vibrating device that is in contact with the human body. In one embodiment, the user wears or carries a small remote device, and the small remote device includes a vibration device. The small remote device vibrates for a predetermined amount of time. In the meanwhile, the WTRU is taking a text or voice message. This allows the user to not respond to the ring, and yet be aware of it. In one configuration, the small remote device includes a small alphanumeric display and has a selectable ring function. In a further embodiment, the remote device includes basic display functions, so that communications from the WTRU can be displayed on the remote device. The provision of a display allows the user to identify the nature of a call without retrieving or physically accessing the WTRU. If the remote device has menu functions, the display can be used to facilitate the menu functions.

It is also possible to provide two-way communication through the small remote device and provide a limited set of functions. The small remote device communicates with the WTRU and the WTRU establishes the necessary communications with a network. In that way, limited functions can be performed through the small remote device. Limited functions can include answering, call by voice command and menu response functions.

In one configuration, it is possible to use the remote device when the WTRU has its telephone “ring” functions essentially off, i.e., “receive only” and quiet mode. When a call comes in, the WTRU offers to take a message and explains to the caller that if this is an important call that requires immediate attention, to so indicate. If the caller provides an indication, then the WTRU sends a “turn on” signal to the remote device. The user then receives the call indication and knows the “important call” indication was provided. In a variation, particular calls are pre-identified, either by the characteristics of the call, e.g., phone number indicated by Caller ID, (CLID) or by a signal provided by the caller. The WTRU sends a “turn on” signal to the remote unit, and the user is thereby made aware of the call.

With a simple modification of the WTRU, the invention can function with a wide variety of WTRUs of any size, with any kind of feature set. This adaptation is made without any substantial changes to the WTRU's size or purpose, and adds a silent alert feature for important and emergency calls.

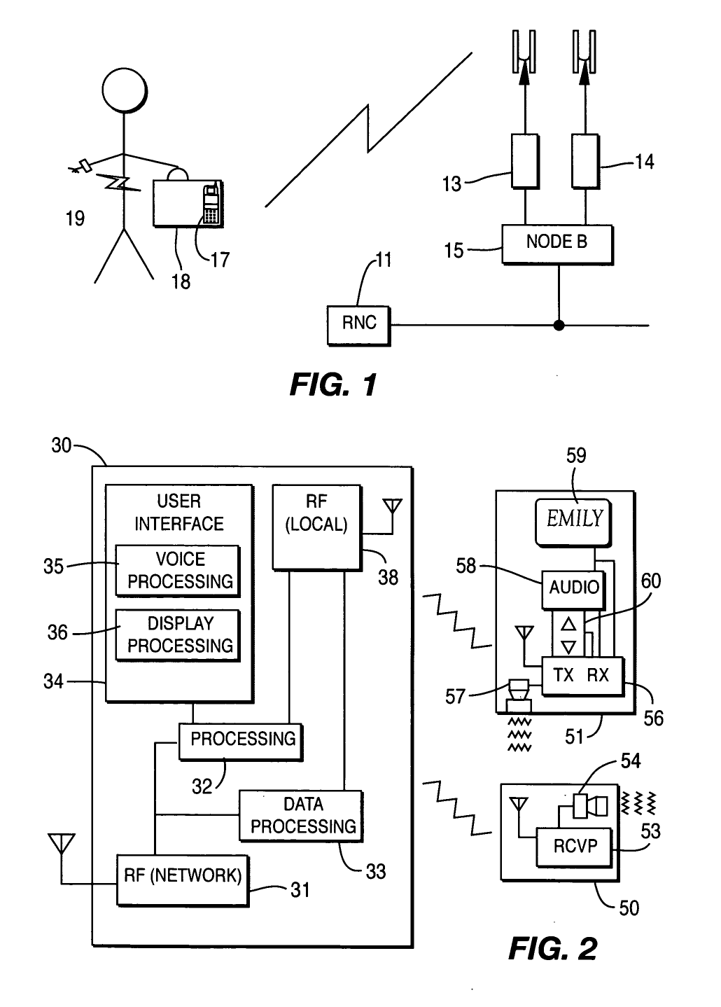

FIG. 1 is a diagram of a system configuration in which a user receives communications from a wireless (such as a cellular) network indirectly by use of a remote device. For one illustrative cellular network, a radio network controller 11 communicates with one or more base stations 13, 14, through a Node B 15. A radio link is established with a WTRU 17. In the pictorial, the WTRU 17 is depicted as stowed inside a briefcase or carry bag 18. A remote signaling device 19 is worn by the user and the WTRU 17 communicates with the remote signaling device 19.

The remote device 19 remotely provides functions of another device. In some embodiment, the device is remote to a WTRU 17 and functions through the WTRU. In some embodiments, the devices also provides control functions for the WTRU 17. While it is possible to combine the remote device 19 with WTRU functions, the basic function of the remote device 19 is to execute its radio communications through the WTRU 17.

In operation, a user may wish to respond to (or not respond to) calls from a particular caller on a WTRU configured as a cellphone. The user puts the WTRU 17 in a “remote signaling” mode wherein the WTRU 17 has an outbound transmission link to the remote device 19. When the WTRU 17 receives the ring signal, it preferably remains quiet. (It may or may not vibrate.) The WTRU 17 sends a unique point to point signal to the remote device 19. The remote device 19 indicates to the user receipt of the call, such as by using a vibrating device in contact with the human body.

In one embodiment, incoming calls to the WTRU 17 are classified and at least one group of higher priority calls are provided by the classification. The classification can be in accordance with a database such as an address book on the WTRU 17, from an external source, or from an query made by the WTRU 17 or a cellular network in response to a call.

In one embodiment, the database presents a case of interaction between the WTRU 17, the wireless infrastructure (RNC 11, Node B 15) and the remote device 19. Typically, the WTRU 17 stores the database, often as a user's address book, but voicemail and a signal that a call is accepted is provided by the wireless infrastructure. According to one aspect, the WTRU 17, upon receiving an indication of a call, replies back to the wireless infrastructure that the call has a defined classification in accordance with a user-identification of the particular number. This identification can be based on the caller's reported number being in the user's address book stored in the WTRU 17, or can be based on the caller's reported number being in one of a group of selected entries in the user's address book, or all calls meeting predetermined characteristics. The particular criteria for classification are a matter of design choice and user selection. By way of example, a user may assign a default classification based on the WTRU's address book or other database, and assign a specific classification to particular numbers in the database, and incorporate caller response into the classification. Thus, a call from a particular number may be assigned high priority with no caller query, a call from another number may be assigned a lower priority unless the caller indicates a higher priority in response to a caller query, and calls to another number may be designated as low priority with no query option. It may also be possible to designate more than one level of priority to be signaled to the user, on the presumption that the user may be willing to respond to lower priority calls in some circumstances.

According to the classification of the call, the wireless infrastructure executes a query, attempts to complete the call to the WTRU 17, places the call to voicemail or otherwise disposes of the call. The function is selected in accordance with the initial classification response from the WTRU 17.

The interaction of the wireless infrastructure with the WTRU 17 can use a user controlled call rejection service. User controlled call rejection, in one variant, is administered by the wireless infrastructure using commands executed by the user, such as through the WTRU 17. Therefore, the remote signaling device would not require compatibility with the wireless infrastructure.

If the user is able to see a display of the initial information, the classification function permits the user to manually effect a classification response. The use of predetermined characteristics also allows the user to select area codes, exchanges, and the like so that calls deemed likely to originate from a given source can be given a classification by the user. If the remote signaling device 19 is configured without a display, then the user can still be notified of multiple classifications of calls by different vibration patterns or other annunciations.

In other embodiments, a voicemail function at the WTRU 17 is provided, in which, it is not necessary to interact with the wireless infrastructure to determine handling of the call for classification purposes, and all responses would be transparent to the wireless interface.

The query is advantageous because the caller generally does not know the particular circumstances of the user of the WTRU 17. Therefore, a friend may be calling to “chat” or discuss issues of general priority while the user of the WTRU 17 is engaged in an activity in which answering the call would be inappropriate to the circumstances. The caller then is able to decide whether to describe the call as important so that the user is notified of the call. In a preferred embodiment, the classification of the call can be integrated with a “voicemail” capability.

The ability to classify calls has a further advantage in countries which still permit unsolicited commercial calls to cellphones. By blocking calls which are not in user-defined classes, the user can avoid being notified of such unsolicited commercial calls through the remote unit.

The signaling function may incorporate diverse functions, provided that the WTRU 17 is able to receive signals relating to the diverse functions, or a separate local RF device is provided. This permits the remote signaling device 19 to be used for multiple uses. By way of example, if the WTRU 17 is associated with a computer or otherwise is able to receive an appropriate signal, the user can be notified of receipt of email of a particular type or classification.

FIG. 2 is a schematic block diagram of a WTRU 30 in which communications with a local RF section 31 is used to connect to the network. The WTRU 30 also includes processing circuitry 32 for voice communications, processing circuitry 33 for data transfer and a user interface 34. The user interface includes voice processing circuitry 35 and a display 36 in order to permit calls to be sent and received, along with information concerning the calls. In addition, a local RF section 38 is provided.

The local RF section 38 is capable of signaling calls to one or more remote signaling devices 50, 51. Remote signaling device 50 is shown as including a receiver 53 and a vibrating annunciator 54. If worn as a wristband or otherwise able to be felt by the user, the vibrating annunciator 54 provides an indication in response to a signal from the WTRU 30 transmitted through the local RF section 38.

Remote signaling device 51 includes a transceiver 56 and a vibrating annunciator 57. As is the case with remote signaling device 50, the vibrating annunciator 57 provides an indication in response to a signal from the WTRU 30 transmitted through the local RF section 38. In addition, remote signaling device 51 includes an audio circuit 58 and a display 59. This permits remote signaling device to provide communications with the WTRU 30, and more significantly, communications with the network through WTRU 30. Since the communications between the remotes 50, 51 and the WTRU 30 do not require network intervention, network restrictions regarding numbers of units on the same voice communications channel and discrete communications with multiple users, typically, do not apply to the remotes 50, 51.

While an RF local circuit is shown, it is also possible that the WTRU 30 is configured to communicate with a LAN. If that is the case, the communications with the remotes 50, 51 can be executed via circuitry which is also used to communicate with the LAN. This could be either through a separate RF transceiver, such as local RF section 38, or through the network RF section 31, according to design choice.

In preferred embodiment, one or more persons wear a wrist band (for example using a Velcro strap) with a vibration device. The vibration device vibrates for a predetermined period of time or as a “ring” signal. Since the vibratory unit is in close contact with the human body, the vibratory unit can be fairly small. In this manner, if the user determines not to answer the call, the caller may leave a message and the user can call back at a convenient time.

This allows receipt of communications when the phone is essentially off, i.e., in a quiet mode. By way of example, the WTRU 30 can be configured so that when a call comes in, the caller receives a message that if this is an important call that requires immediate attention to respond, for example by pressing a particular number. In accordance with the response, the WTRU 30 sends a paging signal to the remote unit, causing the wrist vibrator to signal the user. By restricting calls for which the paging signal is transmitted to a predetermined class of calls, the user is informed that the call is given a high priority.

If the wrist unit is provided with a display, then the display provides further information regarding the call, such as the source of the call. The user may then respond as desired. In the case of alerts other than calls, the display can indicate a general nature of the alert, such as: “CRIB” “OVEN” “PILLS” “FRONT DOOR”. These events may be internal alarm events or external events. The ability to receive RF signals allows signaling from other devices, such as a baby monitor, an oven, a reminder alarm or a door monitor, respectively.

The wearable device thereby alerts its user to predetermined events programmed by the user. It relays alerts, alarms, and short text messages from monitors, microprocessor-based appliances, security systems, etc., that are transmitted from these devices. It is possible to provide the remote signaling device with a capability of transmitting an acknowledgment (ACK), negative acknowledgment (NACK), or simple command back to a monitor sending a warning in order to activate a switch, sound a general alarm, etc.

The use of the remote unit allows the signaling to the user to be in a manner which is appropriate to the circumstances. The user may be alerted in a manner which does not require that the WTRU 30 be physically on the person of the user, and yet still be reasonably certain to receive important calls.

Since the communication link between the WTRU 30 and the remote unit 50, 51 is independent of the cellular network, it is possible to provide multiple remote units, such as remotes 50, 51 depicted in FIG. 2. This has the function of notifying multiple people. In addition, if the remote unit 50,51 has a two-way communication capability, the remote unit 50,51 can be used to provide multiple extensions for communication. Since a single WTRU 30 may be engaged by the multiple remote units, the cellular network need only effect communications with one WTRU device 30.

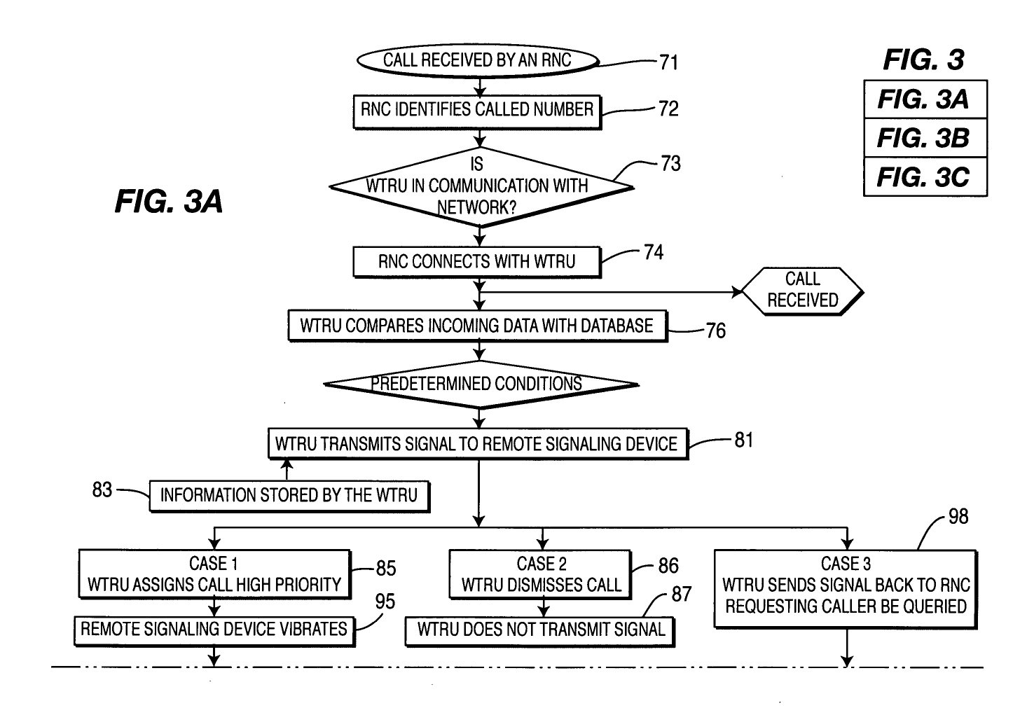

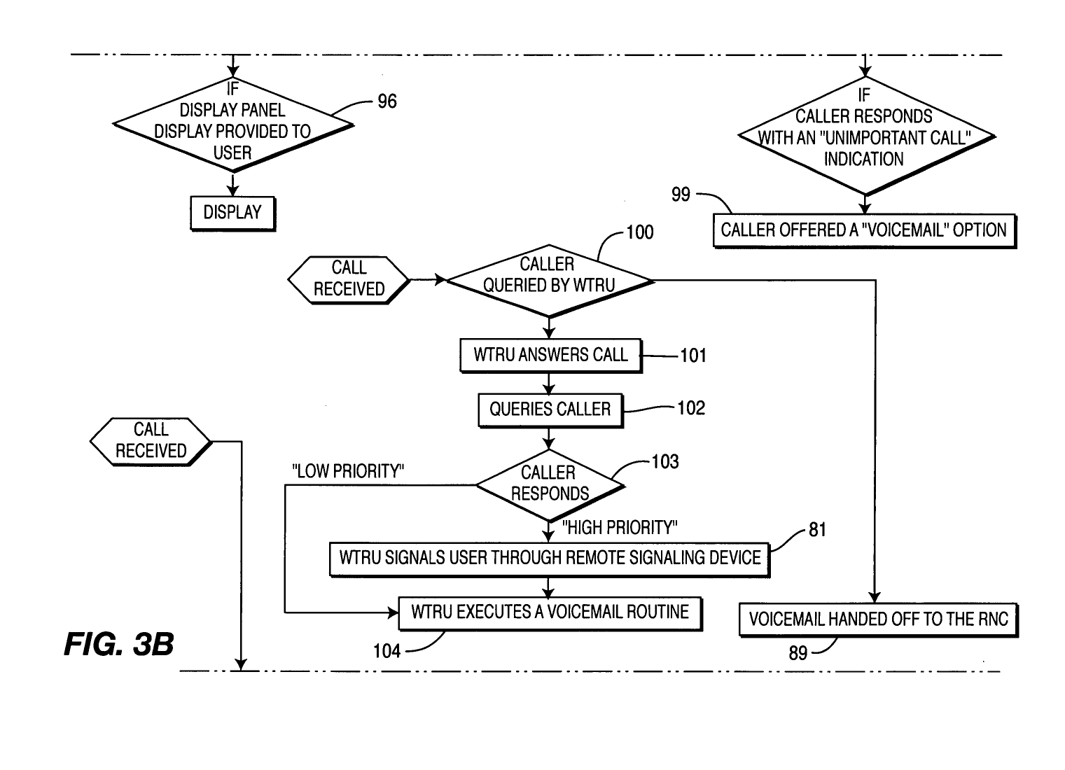

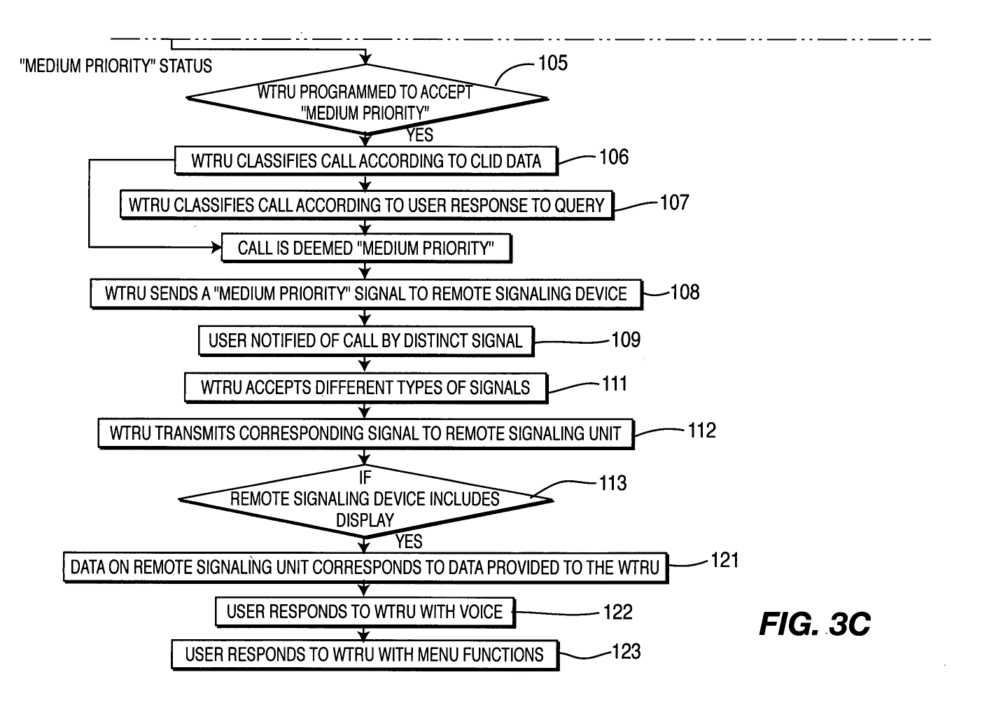

FIGS. 3A-3C are a flow diagram which shows a typical operation of an exemplary embodiment. A call is received by an RNC or other network infrastructure device (Step 71). The RNC identifies a WTRU assigned to the called number (Step 72). The RNC determines if the WTRU is in communication with the network (Step 73), and if the WTRU is in communication with the network, the RNC attempts to make a connection with a WTRU to which the call is directed (Step 74). This normally results in the phone ringing; however the WTRU's initial response is to receive the call and any caller ID data provided by the network and for which the WTRU is intended to receive. The WTRU then compares the incoming data with its database (Step 76) which typically allows the WTRU to display address book data corresponding to the incoming CLID signals. The WTRU's ring response is in accordance with its programming, which can vary from silent vibration to loudly playing a tune, and some WTRUs may use CLID data to provide different types of rings in accordance with the CLID data. The WTRU is set to respond to the incoming call by transmitting a signal to the remote signaling device (Step 81) under predetermined conditions.

A first set of conditions for transmitting a signal to the remote signaling device (Step 81) is an internal classification by the WTRU based on database information stored by the WTRU (Step 83). If (Case 1) the WTRU is programmed by the user to assign a particular class of call high priority, then the signal is transmitted to the remote signaling device in Step 81. Likewise, if (Case 2) the WTRU is programmed by the user to dismiss the call, then the WTRU does not transmit the signal to the remote signaling device in Step 81. In either Case 1 or 2, the execution is performed by the WTRU independent of the RNC.

In response to the transmission of the signal to the remote signaling device, the remote signaling device provides an annunciation signal to the user, such as by vibrating (Step 95). If a display panel is provided, the remote signaling device provides a display to the user (Step 96) showing information concerning the call, such as the name of the user from the WTRU's database, or CLID information. The display of information can also be a duplication of a part of the display of the WTRU or of the entire display on the WTRU.

If the call is classified as assigned a priority according to a query response (Case 3), the WTRU sends a signal back to the RNC acknowledging the call and requesting that the caller be queried (Step 98). The query function is preferably provided by the RNC as a part of a “voicemail” service, but can also be provided by the WTRU. In the preferred configuration, the “voicemail” is associated with the query function because if the user does not respond, or if the caller responds with an “unimportant call” indication, the caller would preferably be offered a “voicemail” option (Step 99). If the caller is to be queried by the WTRU (Step 100), the WTRU answers the call (Step 101) and queries the caller (Step 102). The caller then responds (Step 103) with either an indication of low priority or an indication of high priority. The WTRU either signals the user through the remote signaling device (Step 81) or executes a voicemail routine (Step 104). The voicemail routine can be either integral with the WTRU, part of an external device associated with the WTRU or handed off to the RNC to be integrated with a network-based voicemail service (Step 99). If the WTRU is integrated with a computer as an external device, the voicemail functions is easily implemented without additional hardware.

Additional functions include a “medium priority” status. This could be based on a predetermined combination of the source as indicated by CLID information and the user response. When the WTRU is programmed to accept “medium priority” (Step 105), the WTRU classifies the call according to CLID data (Step 106) or user response to a query (Step 107). If the call is deemed “medium priority”, the WTRU sends a “medium priority” signal to the remote signaling device (Step 108) and the user is notified of the call by a distinct signal (Step 109). The “medium priority” function may be distinguished primarily by user programming.

The WTRU may also accept different types of signals (Step 111) such as receipt of a message, receipt of email of a predetermined category, or an appliance or monitor notification. The WTRU transmits a corresponding signal to the remote signaling unit (Step 112) which notifies the user. If the remote signaling device includes a display, the display indicates the nature of the notification to the user (Step 113).

The remote signaling device, in its more elaborate form, may provide a capability of interactively interfacing with the WTRU. The user is able to receive data on the remote signaling unit corresponding to the data provided to the WTRU (Step 121). The user may respond to the WTRU with voice (Step 122) or with menu functions on the remote signaling device (Step 123).

As can be seen, there are a variety of configurations available, some of which are design choices and some of which are user programmed.

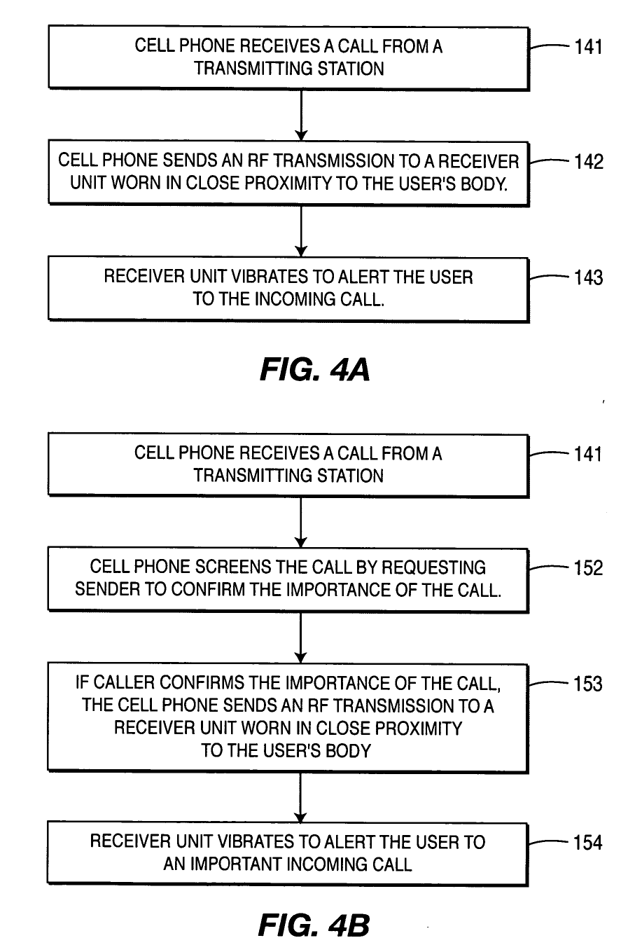

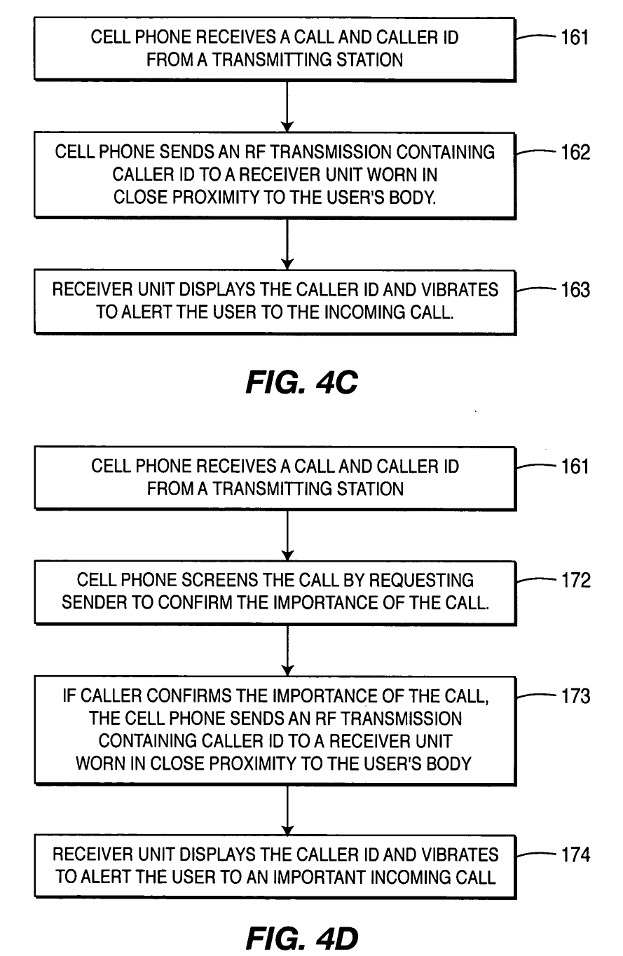

FIGS. 4A-4D are functional flow diagrams showing specific operational examples for providing call notification.

FIG. 4A shows the system without a display function on the remote signaling device and without pre-screening calls. The WTRU receives a call from a transmitting station (Step 141). The WTRU then sends an RF transmission to a receiver in the remote signaling device (Step 142). The remote signaling device vibrates to alert the user to the incoming call (Step 143).

FIG. 4B shows the system without a display function, but with a capability provided for pre-screening calls. The pre-screening can be achieved by the WTRU or by the remote signaling unit. A call is received (Step 141). The call is screened by requesting the sender to confirm the importance of the call (Step 152). This query can be performed either by the WTRU or by the RNC. If the caller confirms the importance of the call, the WTRU then sends an RF transmission to a receiver in the remote signaling device (Step 153), indicating a “high priority” call. The remote signaling device vibrates to alert the user to the incoming call (Step 154). It is noted that the entire pre-screening process can also be performed by the RNC.

FIG. 4C shows the system with a display function on the remote signaling device and without pre-screening calls. The WTRU receives a call from a transmitting station, and processes CLID data, which may be combined with database data held by the WTRU (Step 161). The WTRU then sends an RF transmission to a receiver in the remote signaling device (Step 162). The remote signaling device vibrates to alert the user to the incoming call and displays caller ID information (Step 163). This configuration allows the user to operate the remote signaling unit with a minimum of programming, but permits the user to select calls to answer or determine how to call back based on the caller ID information.

FIG. 4D shows the system with both a display function and a capability provided for pre-screening calls. The WTRU receives a call from a transmitting station, and processes CLID data, which may be combined with database data held by the WTRU (Step 161). The call is screened by requesting the sender to confirm the importance of the call (Step 172). If the caller confirms the importance of the call, the WTRU then sends an RF transmission to a receiver in the remote signaling device (Step 173), indicating a “high priority” call along with information derived from caller ID data and the WTRU's database. The remote signaling device vibrates to alert the user to the incoming call (Step 174). This permits the user to select calls to answer or determine how to call back based on the caller ID information. Since the calls are pre-screened, the user can select which calls to receive and the callers can also pre-screen their own calls by responding to the query. If the user has selected multiple levels of remote signaling, the user can decide whether to be signaled by calls of a lesser priority and can decide whether to respond to the lower priority calls.

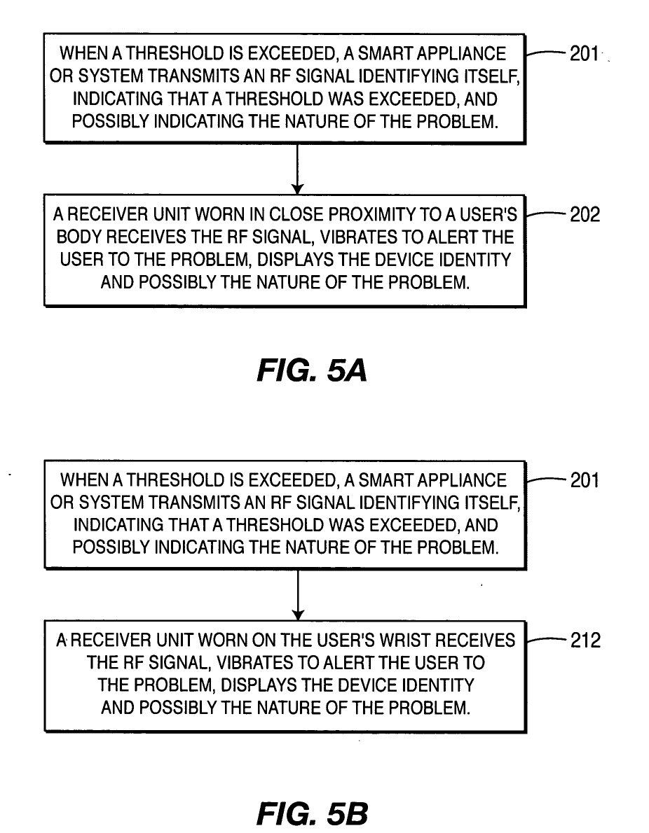

FIGS. 5A-5B are functional flow diagrams showing specific operational examples for providing alerts in accordance with the present invention. In FIG. 5A, a threshold is exceeded on a device and the device transmits a signal, either directly, or through a WTRU (Step 201). The signal is received by a remote signaling device in close proximity to the user alerting the user to a problem or alert (Step 202). In a particular embodiment, the remote signaling device is worn on the user's wrist and the user is signaled (Step 212). A display, which can be either on the remote signaling device or on the WTRU, provides information regarding the problem or alert.

A “punch through” option may also be provided, in which the user provides a simple code to allow high priority handling of the call from any source. This is invoked in the manner of the response of Step 103.

It is also noted that the remote signaling device (19, FIG. 1) can also receive signals from a POTS telephone, or alternately from a POTS telephone and a WTRU (17, FIG. 1)

1. A silent alerting system comprising:
a wearable device comprising:
a vibrator;
a receiver that activates the vibrator upon receiving a predetermined signal;
a power supply that powers the vibrator and receiver; and
a communication device comprising:
a mechanism to link to a wireless network;
a screening mechanism to accept a call of a predetermined classification; and
a mechanism to silence said communication device, record a message, and send the predetermined signal to said receiver upon receipt of said accepted call of a predetermined classification.

2. A wireless transmit/receive unit (WTRU) comprising:
a communications transceiver to communicate with a wireless network in accordance with network protocols;
a local radio link transmitter, receivable by a remote signaling unit, for providing a user with an indication of an incoming call;
circuitry to discriminate between classes of incoming calls and assign priorities to the classes; and
circuitry to transmit data through the local radio link transmitter concerning calls in accordance with at least one assigned priority.

3. The WTRU of claim 2 further comprising the WTRU using a caller response in said discrimination between classes of incoming calls.

4. The WTRU of claim 2 further comprising the local radio link transmitter further providing caller identification data for display on the remote signaling unit.

5. The WTRU of claim 2 further comprising the local radio link transmitter provided as part of a transceiver, thereby permitting the user to communicate through the WTRU by use of the local radio link.

6. The WTRU of claim 2 further comprising:
the WTRU including a circuit which uses a caller response in said discrimination between classes of incoming calls; and
the WTRU using CLID data in said discrimination between classes of incoming calls.

7. The WTRU of claim 2 further comprising:
the local radio transmitter provided a transceiver for providing communication with one or more remote communication units; and
circuitry to transmit data through the local radio link transceiver concerning calls, and to communicate with at least one of the remote communication units, thereby providing simultaneous communication between a wireless network connection and plural ones of the remote communication units.

8. A wearable device comprising:
a receiver to receive and respond to transmissions from a local wireless phone when said phone is called;
a vibrator that is actuated when said receiver receives said transmission; and
a battery to power said receiver and said vibrator,
whereby a user is alerted by said vibrator when said phone is called.

9. The wearable device of claim 8 additionally comprising a means to attach said wearable device in such a way as to maintain it in contact with said user's body.

10. The wearable device of claim 8 additionally comprising a means to keep said wearable device in contact with said user's wrist.

11. The wearable device of claim 8 further comprising an alpha-numeric display, whereby the caller's ID can be displayed.

12. The wearable device of claim 8 further comprising:
an alpha-numeric display, whereby the caller's ID can be displayed; and
a menu function control in communication with the local wireless phone; and
a two-way voice communications capability with the local wireless phone, thereby permitting a user to communicate through the local wireless phone by use of the wearable device.

13. The wearable device of claim 8 further comprising:
an alpha-numeric display, whereby the caller's ID can be displayed; and
a menu function control in communication with the local wireless phone; and
a two-way voice communications capability with the local wireless phone using a shared channel, thereby permitting one or more users to simultaneously communicate through the local wireless phone by use of the wearable device.

14. A wireless transmit/receive unit (WTRU) comprising:
a communications transceiver to communicate with a wireless network in accordance with network protocols;
a local radio link transceiver for communication with at least one remote communication units;
circuitry to transmit data through the local radio link transceiver concerning calls, and to communicate with the at least one remote communication units.

15. A method for providing notifications to a user comprising:
using a wireless electronic device to determine a notification event; and
wirelessly transmitting a local signal in response to the determined notification event.

16. The method of claim 15, comprising providing a receiver capable of providing the user with a vibration signal and able to receive said local signal, thereby providing the notification signal.

17. The method of claim 15, comprising:
classifying at least one group of calls received from a communications system as higher priority calls; and
only providing the local signal in response to receiving said higher priority calls.

18. The method of claim 17, further comprising:
classifying a second priority calls;
providing at least one additional user notification signal in response to receiving the second priority calls.

19. The method of claim 18, wherein the classifying of the high and second priority calls utilizes a database on the communications transceiver.

20. The method of claim 18, wherein the classifying of the high and second priority calls utilizes a database on a radio network.

21. The method of claim 18, wherein the classifying of the high and second priority calls utilizes a response to a query, the query made to an operator making the call.
